(19) United States
(12) Patent Application Publication
(10) Pub. No.: US 2026/0238487 A1
(43) Pub. Date: Aug. 13, 2026

(54) MESSAGE VERIFICATION METHOD AND APPARATUS THEREFOR

(71) Applicant: BEIJING XIAOMI MOBILE SOFTWARE CO., LTD., Beijing (CN)

(72) Inventors: Haoran LIANG, Beijing (CN); Wei LU, Beijing (CN)

(73) Assignee: BEIJING XIAOMI MOBILE SOFTWARE CO., LTD., Beijing (CN)

(21) Appl. No.: 19/155,724

(22) PCT Filed: Feb. 19, 2023
(86) PCT No.: PCT/CN2023/077033

§ 371 Date: Aug. 12, 2025

(51) Int. Cl. H04L 9/32; G06F 21/57

(52) U.S. Cl. CPC H04L 9/3242; G06F 21/575; G06F 2221/034

(57) ABSTRACT

A message verification method, applied to a network device, includes: receiving one or more pre-shared key (PSK) identities sent by a terminal via a datagram transport layer security (DTLS); selecting a PSK identity from the one or more PSK identities and obtaining a key based on the PSK identity selected; sending information related to the PSK identity selected to the terminal; and receiving a message authentication code sent by the terminal and verifying the message authentication code according to the key.

### CROSS REFERENCE TO RELATED APPLICATIONS

This application is a U.S. National Phase of International Application No. PCT/CN 2023/077033, filed on Feb. 19, 2023, the entire contents of which are incorporated herein by reference.

### TECHNICAL FIELD

The disclosure relates to the field of communication technology, in particular to a message verification method and a related apparatus.

### BACKGROUND

In a communication system, an authentication and key management for applications based on 3rd generation partnership project (3GPP) credentials (AKMA) specification and a generic bootstrapping architecture (GBA) specification enable a user equipment (UE) and an application function (AF)/network application function (NAF) to share a common secret key after an application session establishment procedure. However, there is currently no solution that can support the GBA and the AKMA in a datagram transport layer security (DTLS) scenario.

### SUMMARY

According to a first aspect of embodiments of the disclosure, a message verification method is provided. The method is applied to a network device, and includes:
receiving one or more PSK identities sent by a terminal via a DTLS;
selecting a PSK identity from the one or more PSK identities and obtaining a key based on the PSK identity selected;
sending information related to the PSK identity selected to the terminal; and
receiving a message authentication code sent by the terminal, and verifying the message authentication code according to the key.

According to a second aspect of embodiments of the disclosure, a message verification method is provided. The method is applied to a terminal, and includes:
sending one or more PSK identities to a network device via a DTLS;
receiving information related to a selected PSK identity sent by the network device; and
generating a message authentication code according to the information related to the selected PSK identity, and sending the message authentication code and/or the selected PSK identity to the network device.

According to a third aspect of embodiments of the disclosure, a communication device is provided. The communication device includes: a processor and a memory having a computer program stored thereon. The processor executes the computer program stored in the memory to cause the communication device to implement the method described in the first aspect above.

According to a fourth aspect of embodiments of the disclosure, a communication device is provided. The communication device includes: a processor and a memory having a computer program stored thereon. The processor executes the computer program stored in the memory to cause the communication device is caused to implement the method described in the second aspect above.

According to a fifth aspect of embodiments of the disclosure, a non-transitory computer-readable storage medium is provided. The computer-readable storage medium is configured to store instructions used by the above terminal. When the instructions are executed, the terminal is caused to implement the method described in the first aspect above.

According to a sixth aspect of embodiments of the disclosure, a non-transitory readable storage medium is provided. The readable storage medium is configured to store instructions used by the above network device. When the instructions are executed, the network device is caused to implement the method described in the second aspect above.

### BRIEF DESCRIPTION OF THE DRAWINGS

In order to more clearly explain the technical solutions in the embodiments of the disclosure or background technologies, the drawings used in the embodiments of the disclosure or the background technologies are explained below.

FIG. 1 is a schematic structural diagram of a communication system provided by an embodiment of the disclosure.

FIG. 2 is a flowchart of a message verification method provided by an embodiment of the disclosure.

FIG. 3 is a flowchart of a message verification method provided by an embodiment of the disclosure.

FIG. 4 is a flowchart of a message verification method provided by an embodiment of the disclosure.

FIG. 5 is a flowchart of a message verification method provided by an embodiment of the disclosure.

FIG. 6 is a flowchart of a message verification method provided by an embodiment of the disclosure.

FIG. 7 is a schematic structural diagram of a communication apparatus provided by an embodiment of the disclosure.

FIG. 8 is a schematic structural diagram of a communication device provided by an embodiment of the disclosure.

FIG. 9 is a schematic structural diagram of a chip provided by an embodiment of the disclosure.

### DETAILED DESCRIPTION

Reference is made in detail to embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the embodiments of the disclosure. Instead, they are merely examples of apparatuses and methods consistent with aspects related to the embodiments of the disclosure as recited in the attached claims.

The terms used in the embodiments of the disclosure are only for the purpose of describing specific embodiments, and are not intended to limit the embodiments of the disclosure. The singular forms of “a” and “the” used in the embodiments of the disclosure and the attached claims are also intended to include plural forms, unless the context clearly indicates other meanings. It is understandable that the term “and/or” as used herein refers to and includes any or all possible combinations of one or more associated listed items.

It is understandable that although the terms “first”, “second” and “third” may be used in the embodiments of the disclosure to describe various types of information, the information should not be limited to these terms. These terms are only used to distinguish the same type of information from each other. For example, without departing from the scope of the embodiments of the disclosure, the first information may also be referred to as the second information, and similarly, the second information may also be referred to as the first information. Depending on the context, the term “if” as used herein may be interpreted as “when”, “upon” or “in response to determining”.

The network element or network function involved in the embodiments of the disclosure may be implemented by an independent hardware device or by software in the hardware device, which is not limited in the embodiments of the disclosure.

In order to better understand a message verification method disclosed by the embodiments of the disclosure, a communication system to which the embodiments of the disclosure are applied is introduced first.

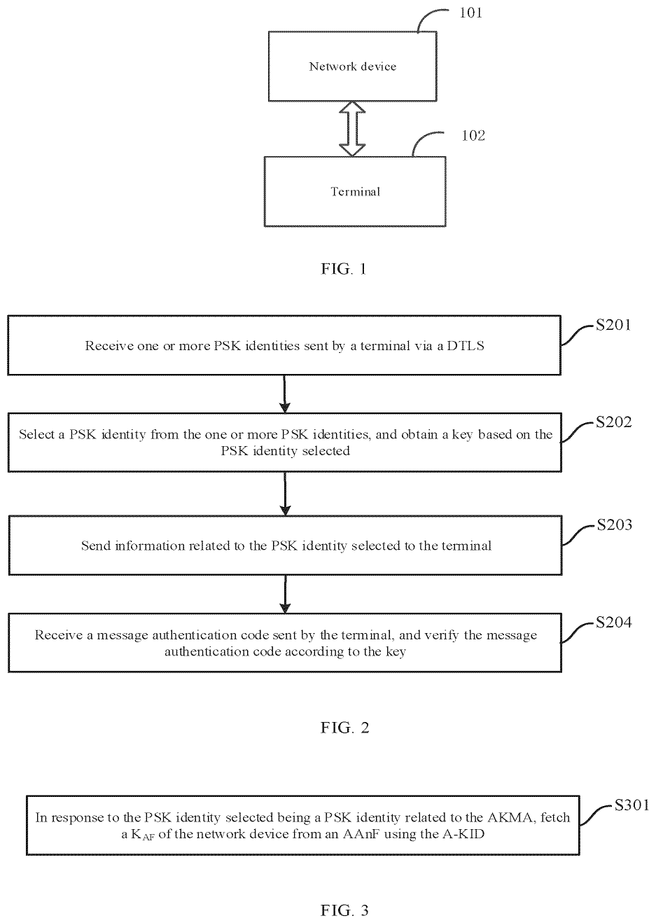

As illustrated in FIG. 1, FIG. 1 is a schematic structural diagram of a communication system provided by an embodiment of the disclosure. The communication system may include, but is not limited to, one network device and one terminal. The number and the form of devices illustrated in FIG. 1 are only for examples and do not constitute as limitations on the embodiments of the disclosure, and two or more network devices and two or more terminals may be included in practical applications. The communication system illustrated in FIG. 1 includes, for example, one network device 101 and one terminal 102.

It should be noted that the technical solution of the embodiments of the disclosure can be applied to various communication systems, such as, a long term evolution (LTE) system, a 5th generation (5G) mobile communication system, a 5G new radio (NR) system, or other future new mobile communication systems. It should also be noted that sidelink in the embodiments of the disclosure may also be referred to as a direct link or a device-to-device link.

The network device 101 in the embodiment of the disclosure is an entity on a network side for transmitting or receiving signals. For example, the network device 101 may be an evolved NodeB (eNB), a transmission reception point (TRP), a next generation NodeB (gNB) in a NR system, a base station in other future mobile communication systems or an access node in a wireless fidelity (Wi-Fi) system. The specific technology and specific device form adopted by the network device are not limited in the embodiments of the disclosure. The network device provided by the embodiment of the disclosure may be composed of a central unit (CU) and a distributed unit (DU). The CU may also be called control unit. The use of CU-DU structure allows to divide a protocol layer of the network device, such as a base station, such that some protocol layer functions are located in the CU for centralized control, and some or all of the remaining protocol layer functions are distributed in the DU, and the DU is centrally controlled by the CU.

The terminal 102 in the embodiment of the disclosure is an entity on a user side for receiving or transmitting signals, such as a cellular phone. The terminal may also be referred to as terminal, user equipment (UE), mobile station (MS), mobile terminal (MT), and the like. The terminal may be a car with communication functions, a smart car, a mobile phone, a wearable device, a Pad, a computer with wireless transceiver functions, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The specific technology and specific device form adopted by the terminal are not limited in the embodiments of the disclosure.

In a communication system, an AKMA specification and a GBA specification enable a UE and an AF/NAF to share a common secret key after an application session establishment procedure.

The AKMA specification (TS 33.535) and the GBA (TS 33.220 and TS 33.222) specifications enable a UE and an Application Function (AF) to share a common secret key after an application session establishment procedure. For protecting the application layer interface Ua* (for AKMA) and Ua (for GBA) between the UE and the AF, various security protocols (e.g. TLS) could be used. One choice for an Internet of Things (IoT) friendly protocol is the IETF DTLS specified in IETF RFC 7252 using the IETF CoAP as an underlying transfer layer.

And in SEAL specification (TS 33.434), communication security for CoAP is based on DTLS or OSCORE. The security of CoAP based on DTLS is specified in RFC 6347. IETF DTLS is currently specified as one choice for providing security for the OMA Lightweight M2M standard.

However, how to utilize DTLS to support the security for Ua interface of GBA and Ua* interface of AKMA is not specified yet.

It is understandable that the communication system described in the embodiments of the disclosure is intended to clearly illustrate the technical solution according to the embodiments of the disclosure, and does not constitute as a limitation on the technical solution according to the embodiments of the disclosure. It is understandable by those skilled in the art that as system architectures evolve and new business scenarios emerge, the technical solution provided by the embodiments of the disclosure are also applicable to similar technical problems.

The message verification method and a related apparatus provided by the disclosure are introduced in detail in combination with the accompanying drawings.

As illustrated in FIG. 2, FIG. 2 is a flowchart of a message verification method provided by an embodiment of the disclosure. The method is applied to a network device. As illustrated in FIG. 2, the method includes, but is not limited to, the following steps.

At step S201, one or more PSK identities sent by a terminal are received via a DTLS.

At step S202, a PSK identity is selected from the one or more PSK identities, and a key is obtained based on the PSK identity selected.

At step S203, information related to the selected PSK identity is sent to the terminal.

At step S204, a message authentication code sent by the terminal is received, and the message authentication code is verified according to the key.

In an embodiment of the disclosure, the network device may receive a DTLS message sent by the terminal, which includes one or more PSK identities supported by the terminal, and the network device can select one PSK identity from the PSK identities. The network device receives the message from the terminal, that is, the network device is associated with the terminal.

In an embodiment of the disclosure, the network device may refer to an AF/NAF entity. In this case, the network device receives the DTLS message sent by the terminal. Based on its own security capability, the network device can also select the PSK identity from the PSK identities received from the terminal. Then, the network device obtains the key based on the selected PSK identity and sends the information related to the selected PSK identity to the terminal.

In an embodiment of the disclosure, after receiving the message authentication code sent by the terminal, the network device verifies the message authentication code according to the obtained key, and the verification result is “success” or “failure”.

In an embodiment of the disclosure, after the message authentication code is successfully verified, the network device may indicate that the identity of the terminal is successfully authenticated.

By implementing the embodiment of the disclosure, the network device may receive the one or more PSK identities from the terminal protected by DTLS, and verifies the message authentication code sent by the terminal with the key associated with the selected PSK identity, so that DTLS can support the security for Ua interface of GBA and Ua* interface of AKMA, thereby improving a communication security.

In an embodiment of the disclosure, the PSK identity includes a first PSK hint and/or an A-KID in an AKMA scenario.

In an embodiment of the disclosure, the first PSK hint includes one of 3GPP-akma and 3GPP-bootstrapping-akma.

In an embodiment of the disclosure, the PSK identity includes a second PSK hint and/or a B-TID in a GBA scenario.

In an embodiment of the disclosure, the second PSK hint includes one of a 3GPP-bootstrapping-uicc, a 3GPP-gba-uicc, a 3GPP-bootstrapping, a 3GPP-gba, and a 3GPP-bootstrapping-digest or a 3GPP-gba-digest.

In an embodiment of the disclosure, the PSK identity includes the A-KID and the B-TID.

In the embodiment, the PSK identity includes both the A-KID in the AKMA scenario and the B-TID in the GBA scenario, the network device needs to select one of the PSK identities supported by the network device and obtain the key based on to the selected PSK identity.

As illustrated in FIG. 3, FIG. 3 is a flowchart of a message verification method provided by an embodiment of the disclosure. The method is applied to a network device. As illustrated in FIG. 3, the method includes, but is not limited to, the following steps.

At step S301, in response to the PSK identity selected being a PSK identity related to an AKMA, a KAF of the network device is fetched from an AAnF using the A-KID.

In the embodiment, after receiving the one or more PSK identities sent by the terminal via the DTLS, the network device needs to select the PSK identity from the PSK identities and obtain the key based on the selected PSK identity. If the selected PSK identity is a PSK identity related to AKMA, the network device fetches the KAF of the network device from the AAnF using the A-KID, and verifies the message authentication code sent by the terminal according to the KAF of the network device, so that DTLS can support the security for the Ua* interface of the AKMA, thereby improving a communication security.

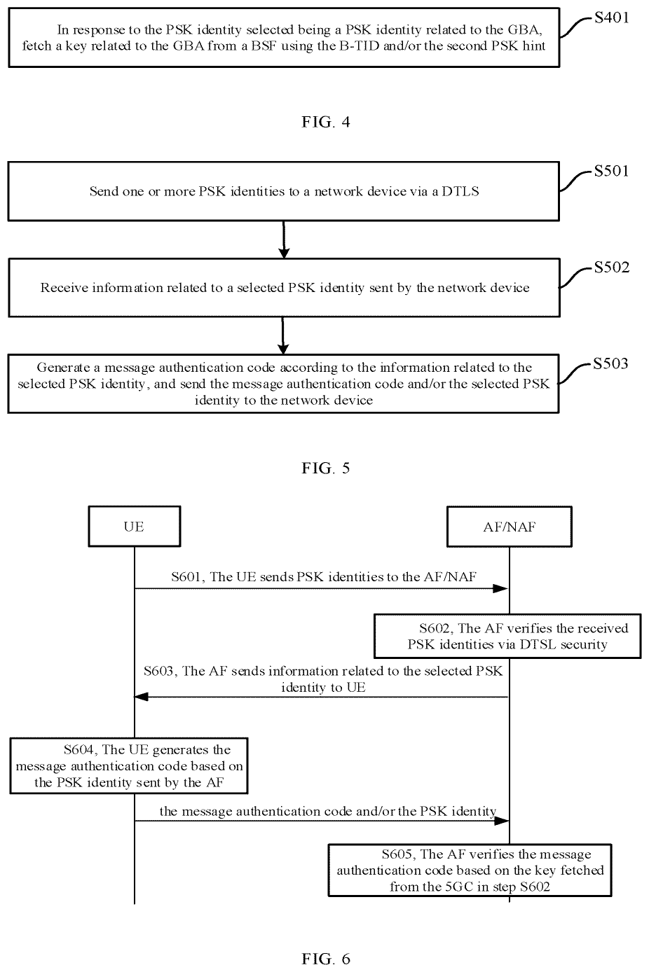

As illustrated in FIG. 4, FIG. 4 is a flowchart of a message verification method provided by an embodiment of the disclosure. The method is applied to a network device. As illustrated in FIG. 4, the method includes, but is not limited to, the following steps.

At step S401, in response to the selected PSK identity being a PSK identity related to GBA, a key related to GBA is fetched from a BSF using the B-TID and/or the second PSK hint.

In the embodiment, after receiving the PSK identities sent by the terminal via the DTLS, the network device needs to select the one PSK identity from the PSK identities and obtain the key based on the selected PSK identity. The selected PSK identity is a PSK identity related to the GBA, i.e., the PSK identity includes a second PSK hint and/or a B-TID in the GBA scenario. The second PSK hint includes one of 3GPP-bootstrapping-uicc, 3GPP-gba-uicc, 3GPP-bootstrapping, 3GPP-gba, 3GPP-bootstrapping-digest or 3GPP-gba-digest. Then, the network device fetches the key related to GBA from the BSF using the B-TID and/or the second PSK hint, and verifies the message authentication code sent by the terminal according to the key related to GBA, so that DTLS can support the security for Ua interface of GBA, thereby improving a communication security.

As illustrated in FIG. 5, FIG. 5 is a flowchart of a message verification method provided by an embodiment of the disclosure. The method is applied to a terminal. As illustrated in FIG. 5, the method includes, but is not limited to, the following steps.

At step S501, one or more PSK identities are sent to a network device via a DTLS.

At step S502, information related to a selected PSK identity sent by the network device is received.

At step S503, a message authentication code is generated according to the information related to the selected PSK identity, and the message authentication code and/or the selected PSK identity is sent to the network device.

In the embodiment, after a DTLS connection has established between the network device and the terminal, the terminal authenticates the identity of the network device via the DTLS, specifically via a certificate of the network device. At this time, the identity of the terminal device is not verified by the network device, and the security of communication cannot be guaranteed. In order to improve the communication security, the terminal sends its supported PSK identities to the network device, and the network device receives the PSK identities sent by the terminal via the DTLS and selects one PSK identity from the PSK identities. Then, the network device obtains the key based on the selected PSK identity, and sends the information related to the selected PSK identity to the terminal. After receiving the information related to the selected PSK identity sent by the network device, the terminal generates the message authentication code and sends the message authentication code and/or the selected PSK identity to the network device. After receiving the message authentication code sent by the terminal, the network device verifies the message authentication code according to the key.

In an embodiment of the disclosure, the network device may receive a DTLS message sent by the terminal, which includes one or more PSK identities supported by the terminal, and the network device may select a PSK identity from the PSK identities. The network device receives the message from the terminal, that is, the network device is associated with the terminal.

In an embodiment of the disclosure, the network device may refer to an AF/NAF entity. In this case, the network device may receive the DTLS message sent by the terminal. Based on its own security capability, the network device can also select the PSK identity from the PSK identities received from the terminal. Then, the network device obtains the key based on the selected PSK identity and sends the information related to the selected PSK identity to the terminal.

In an embodiment of the disclosure, the PSK identity supported by the terminal includes a first PSK hint and/or an A-KID in an AKMA scenario.

In an embodiment of the disclosure, the first PSK hint includes one of 3GPP-akma and 3GPP-bootstrapping-akma.

In an embodiment of the disclosure, the PSK identity includes a second PSK hint and/or a B-TID in a GBA scenario.

In an embodiment of the disclosure, the second PSK hint includes one of a 3GPP-bootstrapping-uicc, a 3GPP-gba-uicc, a 3GPP-bootstrapping, a 3GPP-gba, and a 3GPP-bootstrapping-digest or a 3GPP-gba-digest.

In an embodiment of the disclosure, the PSK identity supported by the terminal includes the A-KID and the B-TID.

In the embodiment, the PSK identity includes both the A-KID in the AKMA scenario and the B-TID in the GBA scenario, the network device needs to select one of the PSK identities and obtain the key based on the selected PSK identity.

In an embodiment of the disclosure, after receiving the message authentication code sent by the terminal, the network device verifies the message authentication code according to the obtained key, and the verification result is “success” or “failure”.

In an embodiment of the disclosure, after the message authentication code is verified successfully, the network device may indicate that the terminal is successfully authenticated.

Through the solution, the network device may receive the PSK identity from the terminal protected by DTLS, and verifies the message authentication code sent by the terminal using the key associated with the selected PSK identity, so that DTLS can support the security for the Ua interface of the GBA and the Ua* interface of the AKMA, which improves a communication security.

In a possible embodiment, the terminal is a UE, and the network device is an AF. The premise of the embodiment is that the DTLS connection between UE and AF has been established. UE has authenticated the identity of the AF via the DTLS. The identity of the AF is authenticated via the certificate of the AF. But the identity of the UE is not authenticated by the AF.

As illustrated in FIG. 6, FIG. 6 is a flowchart of a message verification method provided by an embodiment of the disclosure. As illustrated in FIG. 6, the method includes, but is not limited to, the following steps.

At step S601, UE sends PSK identities to the AF/NAF. The UE sends all PSK identities it supports, including the IDs for e.g. AKMA and GBA. The PSK identities are protected by DTLS.

For AKMA scenarios, the PSK identity is consisting of PSK hint (i.e. “3GPP-AKMA”) and the A-KID.

For GBA scenarios, the PSK identity is consisting of PSK hint (e.g., “3GPP-bootstrapping-uicc”, “3gpp-gba-uicc”, “3GPP-bootstrapping”, “3GPP-gba”, “3GPP-bootstrapping-digest”, or “3GPP-gba-digest”) and the B-TID.

At step S602, the AF verifies the received PSK identities via DTSL security. Based on its own security capability, the AF selects the PSK identity received from the UE.

If the AF selects PSK identity related to AKMA, it fetches the AF specific shared secret (KAF) from the AAnF using the A-KID.

If the AF selects the PSK identity related to GBA, it fetches the key related to GBA from the BSF using the B-TID.

At step S603, the AF should send information related to the selected PSK identity (e.g. an indicator of the selected PSK identity) to UE.

The PSK identity is sent to AF via CBOR object signing and encryption (COSE)/concise binary object representation (COBR)/constrained application protocol (CoAP) message.

In a possible implementation, the PSK identity is sent via a kid parameter or a recipients structure in the COSE/CoAP message.

At step S604, UE generates the message authentication code based on the PSK identity sent by the AF, and sends the message authentication code and/or the PSK identity to the AF.

At step S605, the AF verifies the message authentication code based on the key fetched from the 5GC in step S602. If the message authentication code is verified, then the identity of UE is verified.

In the above embodiments provided by the disclosure, the methods provided by the embodiments of the disclosure are introduced from the perspectives of the network device and the terminal, respectively. In order to realize the functions in the methods provided by the embodiments of the disclosure, the network device and the terminal may each include a hardware structure and a software module, and the above functions are implemented in the form of the hardware structure, the software module, or a combination of the hardware structure and the software module. One of the above functions may be implemented in the hardware structure, the software module, or a combination of the hardware structure and the software module.

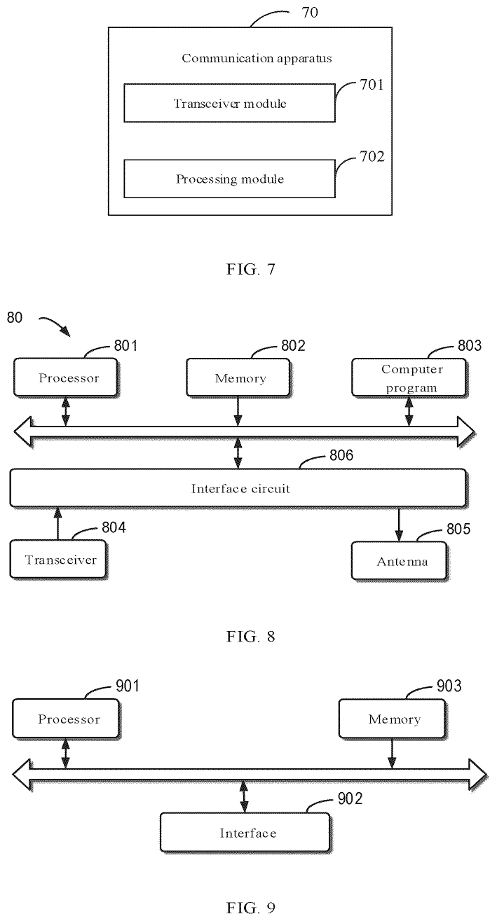

As illustrated in FIG. 7, FIG. 7 is a schematic structural diagram of a communication apparatus 70 provided by an embodiment of the disclosure. The communication apparatus 70 shown in FIG. 7 includes: a transceiver module 701 and a processing module 702. The transceiver module 701 includes: a sending module and/or a receiving module. The sending module is configured to implement a sending function, and the receiving module is configured to implement a receiving function. The transceiver module 701 may implement the sending function and/or the receiving function.

The communication apparatus 70 may be a terminal (e.g., the terminal in the above method embodiments), a device in the terminal, or a device that can be used together with the terminal. Or, the communication apparatus 70 may be a network device, a device in the network device, or a device that can be used together with the network device.

In a case that the communication apparatus 70 is a terminal, the apparatus includes:
a fourth transceiver module, configured to send one or more PSK identities to a network device via a DTLS;
a fifth transceiver module, configured to receive information related to a selected PSK identity sent by the network device; and
a second processing module, configured to generate a message authentication code according to the information related to the selected PSK identity, and send the message authentication code and/or the selected PSK identity to the network device.

In a case that the communication apparatus 70 is a network device, the apparatus includes:
a first transceiver module, configured to receive one or more PSK identities sent by a terminal via a DTLS;
a first processing module, configured to select a PSK identity from the one or more PSK identities, and obtain a key based on the PSK identity selected;
a second transceiver module, configured to send information related to the PSK identity selected to the terminal; and
a third transceiver module, configured to receive a message authentication code sent by the terminal, and verify the message authentication code according to the key.

FIG. 8 is a schematic structural diagram of a communication device 80 provided by an embodiment of the disclosure. The communication device 80 may be a network device, a terminal (e.g., the terminal in the above method embodiments), or a chip, a chip system or a processor that supports the network device to implement the above-described method, or a chip, a chip system or a processor that supports the terminal to implement the above-described method. The device may be used to implement the methods described in the above method embodiments with reference to the description of the above-described method embodiments.

The communication device 80 may include one or more processors 801. The processor 801 may be a general purpose processor or a dedicated processor, such as, a baseband processor or a central processor. The baseband processor is used for processing communication protocols and communication data. The central processor is used for controlling a communication device (e.g., base station, baseband chip, terminal, terminal chip, DU, or CU), executing computer programs, and processing data of the computer programs.

In an embodiment of the disclosure, the communication device 80 may include one or more memories 802 on which computer programs 803 may be stored. The processor 801 executes the computer programs 803 to cause the communication device 80 to perform the methods described in the above method embodiments. In an embodiment of the disclosure, the memory 802 may also store data. The communication device 80 and the memory 802 may be provided separately or may be integrated together.

In an embodiment of the disclosure, the communication device 80 may also include a transceiver 804 and an antenna 805. The transceiver 804 may be referred to as transceiver unit, transceiver machine, or transceiver circuit, for realizing a transceiver function. The transceiver 804 may include a receiver and a transmitter. The receiver may be referred to as receiver machine or receiving circuit, for realizing a receiving function. The transmitter may be referred to as transmitter machine or transmitting circuit, for realizing a transmitting function.

In an embodiment of the disclosure, the communication device 80 may also include one or more interface circuits 806. The interface circuits 806 are used to receive code instructions and transmit the code instructions to the processor 801. The processor 801 runs the code instructions to cause the communication device 80 to perform the methods described in the above method embodiments.

In a case that the communication device 80 is a terminal (e.g., the terminal in the above method embodiments), the processor 801 is used to execute step S202 in FIG. 2, step S302 in FIG. 3a, step S402 in FIG. 4, step S502 in FIG. 5 or step S604 in FIG. 6. The processor 801 is used to execute step S601 in FIG. 6.

In a case that the communication device 80 is a network device, the transceiver 804 is used to execute step S201 in FIG. 2, step S301 in FIG. 3a, step S401 in FIG. 4, step S501 in FIG. 5 or step S603 in FIG. 6. The processor 801 is used to execute step S602 in FIG. 6.

In an implementation, the processor 801 may include a transceiver for implementing the receiving and transmitting functions. The transceiver may be, for example, a transceiver circuit, an interface or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 801 may store a computer program 803 that can be executed by the processor 801 and may cause the communication device 80 to perform the methods described in the method embodiments above. The computer program 803 may be solidified in the processor 801, in which case the processor 801 may be implemented by hardware.

In an implementation, the communication device 80 may include circuits. The circuits may implement the sending, receiving or communicating function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs) and electronic devices. The processor and the transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the description of the above embodiments may be a network device or a terminal (e.g., the terminal in the above method embodiments), but the scope of the communication device described in the disclosure is not limited thereto, and the structure of the communication device is not limited by FIG. 8. The communication device may be a stand-alone device or may be part of a larger device. For example, the communication device may be:
(1) a stand-alone IC, chip, chip system or subsystem;
(2) a collection of ICs including one or more ICs, in an embodiment of the disclosure, the collection of ICs may also include storage components for storing data and computer programs;
(3) an ASIC, such as a modem;
(4) modules that can be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

The case that the communication device is a chip or a chip system can refer to the schematic structural diagram of a chip in FIG. 9. In FIG. 9, the chip includes a processor 901 and an interface 902. There may be one or more processors 901, and there may be multiple interfaces 902.

In an embodiment of the disclosure, the chip may also include a memory 903 for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described functions, but such implementations should not be construed as being beyond the scope of protection of the embodiments of the disclosure.

The embodiment of the disclosure also provides a message authentication system. The system includes a communication device as a terminal (e.g., the terminal in the above method embodiments) and a communication device as a network device in the embodiment of FIG. 7, or the system includes a communication device as a terminal (e.g., the terminal in the above method embodiments) and a communication device as a network device in the embodiment of FIG. 8.

The disclosure also provides a non-transitory computer-readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs)) or wirelessly (e.g., by using infrared wave, wireless wave, or microwave). The non-transitory computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second” and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four or more, which is not limited in the disclosure. In the embodiment of the disclosure, for a type of technical features, “first”, “second” and “third”, and “A”, “B”, “C” and “D” are used to distinguish different technical features of the type, the technical features described using the “first”, “second” and “third”, and “A”, “B”, “C” and “D” do not indicate any order of precedence or magnitude.

The correspondences shown in the tables in the disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in the disclosure may not be configured. For another example, the above tables may be adjusted appropriately, such as splitting, combining, and the like. The names of the parameters shown in the titles of the above tables may be other names that may be understood by the communication device, and the values or representations of the parameters may be other values or representations that may be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in the disclosure may be understood as define, pre-define, store, pre-store, pre-negotiate, pre-configure, solidify, or pre-fire.

Those skilled in the art may realize that the units and algorithmic steps of various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above can refer to the corresponding processes in the preceding method embodiments, which are not repeated herein.

The above are only specific implementations of the disclosure, but the scope of protection of the disclosure is not limited thereto. Those skilled in the art familiar to the technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A message verification method, applied to a network device, comprising:
receiving one or more pre-shared key (PSK) identities sent by a terminal via a datagram transport layer security (DTLS);
selecting a PSK identity from the one or more PSK identities and obtaining a key based on the PSK identity selected;
sending information related to the PSK identity selected to the terminal; and
receiving a message authentication code sent by the terminal and verifying the message authentication code according to the key.

2. The method of claim 1, wherein the PSK identity comprises at least one of a first PSK hint or an authentication and key management for applications based on 3rd generation partnership project (3GPP) credentials (AKMA) key identifier (A-KID) in an AKMA scenario.

3. The method of claim 2, wherein the first PSK hint comprises one of a 3GPP-akma or a 3GPP-bootstrapping-akma.

4. The method of claim 1, wherein the PSK identity comprises at least one of a second PSK hint or a bootstrapping transaction identifier (B-TID) in a generic bootstrapping architecture (GBA) scenario.

5. The method of claim 4, wherein the second PSK hint comprises one of a 3GPP-bootstrapping-uicc, a 3GPP-gba-uicc, a 3GPP-bootstrapping, a 3GPP-gba, and a 3GPP-bootstrapping-digest or a 3GPP-gba-digest.

6. The method of claim 2, wherein the PSK identity comprises the A-KID and a B-TID.

7. The method of claim 2, wherein obtaining the key based on the PSK identity selected comprises:
in response to the PSK identity selected being a PSK identity related to an AKMA, fetching an application function specific shared secret (K_{AF}) of the network device from an AKMA anchor function (AAnF) using the A-KID.

8. The method of claim 4, wherein obtaining the key based on the PSK identity selected comprises:
in response to the PSK identity selected being a PSK identity related to the GBA, fetching a key related to the GBA from a bootstrapping server function (BSF) using at least one of the B-TID or the second PSK hint.

9. A message verification method, applied to a terminal, comprising:
sending one or more pre-shared key (PSK) identities to a network device via a datagram transport layer security (DTLS);
receiving information related to a selected PSK identity sent by the network device; and
generating a message authentication code according to the information related to the selected PSK identity and sending at least one of the message authentication code or the selected PSK identity to the network device.

10. (canceled)

11. (canceled)

12. A communication device, comprising a processor and a memory, wherein the memory stores a computer program, and the processor executes the computer program stored in the memory to cause the device to:
receive one or more PSK identities sent by a terminal via a DTLS;
select a PSK identity from the one or more PSK identities and obtaining a key based on the PSK identity selected;
send information related to the PSK identity selected to the terminal; and
receive a message authentication code sent by the terminal and verifying the message authentication code according to the key.

13. (canceled)

14. A non-transitory computer-readable storage medium, wherein the storage medium is configured to store instructions, and when the instructions are executed, the method according to claim 1 is implemented.

15. A non-transitory computer-readable storage medium, wherein the storage medium is configured to store instructions, and when the instructions are executed, the method according to claim 9 is implemented.

16. A communication device, comprising a processor and a memory, wherein the memory stores a computer program, and the processor executes the computer program stored in the memory to cause the device to implement the method according to claim 9.

17. The communication device of claim 12, wherein the PSK identity comprises at least one of a first PSK hint or an AKMA A-KID in an AKMA scenario.

18. The communication device of claim 17, wherein the first PSK hint comprises one of a 3GPP-akma and a 3GPP-bootstrapping-akma.

19. The communication device of claim 12, wherein the PSK identity comprises at least one of a second PSK hint or a B-TID in a GBA scenario.

20. The communication device of claim 19, wherein the second PSK hint comprises one of a 3GPP-bootstrapping-uicc, a 3GPP-gba-uicc, a 3GPP-bootstrapping, a 3GPP-gba, and a 3GPP-bootstrapping-digest or a 3GPP-gba-digest.

21. The communication device of claim 17, wherein the PSK identity comprises the A-KID and a B-TID.

22. The communication device of claim 17, wherein obtaining the key based on the PSK identity selected comprises:
in response to the PSK identity selected being a PSK identity related to an AKMA, fetching a K_{AF} of the network device from an AAnF using the A-KID.

23. The communication device of claim 19, wherein obtaining the key based on the PSK identity selected comprises:
in response to the PSK identity selected being a PSK identity related to the GBA, fetching a key related to the GBA from a BSF using at least one of the B-TID or the second PSK hint.
